(19) United States
(12) Patent Application Publication
(10) Pub. No.: US 2025/0245369 A1
(43) Pub. Date: Jul. 31, 2025

(54) DATA PROCESSING SYSTEM CAPABLE OF MANAGING AUTHORITIES OF APPLICATION PROCESSES

(71) Applicant: TrustONE Security Inc., Taipei City (TW)

(72) Inventors: Yuan-Hao CHEN, Taipei City (TW); Ting-Huang CHEN, Keelung City (TW)

(21) Appl. No.: 19/027,719

(22) Filed: Jan. 17, 2025

(30) Foreign Application Priority Data
Jan. 30, 2024 (TW) 113103532

(51) Int. Cl. G06F 21/62

(52) U.S. Cl. CPC G06F 21/6218

(57) ABSTRACT

A data processing system, capable of managing authorities of application processes, includes a data storage device and at least one processor. The at least one processor executes an operating system including an authority rule recording module, a process authority rule recording module, a process authority status recording module, a process managing module, a message transmitting module, and an access control module. The process managing module determines the authority of an application process to access a plurality of files stored in the data storage device in according with N process authority status information stored in the process authority status recording module, a plurality of sequential process authority rule information stored in the process authority rule recording module, and a plurality of authority information stored in the authority rule recording module.

### CROSS-REFERENCE TO RELATED APPLICATION

This utility application claims priority to Taiwan Application Serial Number 113103532, filed Jan. 30, 2024, which is incorporated herein by reference.

### BACKGROUND OF THE INVENTION

### 1. Field of the Invention

The invention relates to a data processing system capable of managing authorities of application processes, and more in particular, to a data processing system capable of dynamically managing authorities of application processes.

### 2. Description of the Prior Art

Many information security software, in order to protect the files stored in the data processing system, defines a security list of application processes. If the name of the application process is recorded in the security list in advance, the application process can access the protected files. If the name of the application process is not recorded in the security list in advance, the application process cannot access the protected files.

Due to the large number of application processes running in the data processing system and the new application processes loaded in the future, it is not easy for the administrator of the data processing system to determine which application processes should be given what authorities or be prohibited from accessing the files. When the application processes that should be added to the security list are not added, it may cause the data processing system, which the application processes run in, to operate abnormally or even stop functioning. If a malicious process is added to the security list by mistake, it can lead to hacking of the data processing system and even other systems linked to the data processing system.

For example, the files of a web system running in a data processing system need to be protected, and there are different software to run the web system (for example, a java-based web system). When the administrator of the data processing system protects the web system by not allowing any application process to access the files and not adding the java-based application process to the security list of the secure process, it will cause the whole web system to stop operating. Similarly, if a malicious process (for example, virus) should not be added to the security list of the secure process, but the administrator of the data processing system is not aware of it and adds it to the security list, then the malicious process can access the web page data, and then damage the data or steal the data. Therefore, the management of this security list will cause difficulties in the judgment of the administrator when building a data processing system, and will have a great impact on the operation of the data processing system.

### SUMMARY OF THE INVENTION

Accordingly, one scope of the invention is to provide a data processing system capable of dynamically managing authorities of application processes to solve the problems that occurred in the past when the authorities of application processes are controlled by security lists only.

A data processing system according to a first preferred embodiment of the invention is capable of dynamically managing authorities of application processes. The data processing system according to the first preferred embodiment of the invention is capable of communicating with an administrator system. The data processing system according to the first preferred embodiment of the invention includes a data storage device and at least one processor. The data storage device therein stores a plurality of files. The at least one processor is electrically connected to the data storage device, and functions in executing an operating system. The operating system has a system layer and an application layer, and includes an authority rule recording module, a process authority rule recording module, a process authority status recording module, a process managing module, a message transmitting module, and an access control module. The authority rule recording module is resident in the application layer of the operating system. The authority rule recording module therein stores a plurality of authority information. Each authority information includes a plurality of access action setting data. Each access action setting datum includes a respective authority setting datum and a respective notification setting datum. The process authority rule recording module is resident in the application layer of the operating system. The process authority rule recording module therein stores a plurality of sequential process authority rule information. Each process authority rule information includes a respective first characteristic item, a respective first characteristic datum, one of the plurality of authority information, and a respective first authority conversion rule datum. The process authority status recording module is resident in the application layer of the operating system. The process authority status recording module therein stores N process authority status information, where N is an integer larger than or equal to 0. Each process authority status information includes a predetermined process name, one of the plurality of authority information, and a respective second authority conversion rule datum. The process managing module is resident in the application layer of the operating system, and is respectively coupled to the authority rule recording module, the process authority rule recording module and the process authority status recording module. The message transmitting module is resident in the application layer of the operating system, and is coupled to the process managing module. The access control module is resident in the system layer of the operating system, and is respectively coupled to the process managing module and the data storage device. An application process is resident in the application layer of the operating system, and is coupled to the process managing module. The application process therein stores a plurality of second characteristic items and a plurality of second characteristic data. Each second characteristic item corresponds to one of the plurality of second characteristic data. When the application process is executed to access the plurality of files stored in the data storage device via the access control module, the process managing module judges whether a process name of the application process is identical to one of the N predetermined process names of the N process authority status information stored in the process authority status recording module. And if no, the process managing module compares the second characteristic items and the second characteristic data of the application process in order with the first characteristic items and the first characteristic data of the plurality of sequential process authority rule information to determines a first selected authority information from the plurality of authority information of the plurality of sequential process authority rule information and a selected authority conversion rule datum from the plurality of first authority conversion rule data. The process managing module controls the application process to access the plurality of files in accordance with the first selected authority information. The process managing module records the process name, the first selected authority information, and the selected authority conversion rule datum in the process authority status recording module to form a new process authority status information that follows the N process authority status information. The message transmitting module selectively transmits a notification message to the administrator system in accordance with the first selected authority information.

Further, if the message transmitting module does not receive an instructional message sent by the administrator system in response to the notification message, the process managing module changes the first selected authority information into a second selected authority information in accordance with the selected authority conversion rule datum. The second selected authority information is one of the plurality of authority information, and is not identical to the first selected authority information. The process managing module controls the application process to access the plurality of files in accordance with the second selected authority information.

Further, if the message transmitting module receives the instructional message sent by the administrator system in response to the notification message, the process managing module changes the first selected authority information into a third selected authority information in accordance with the instructional message. The third selected authority information is one of the plurality of authority information, and is not identical to the first selected authority information. The process managing module controls the application process to access the plurality of files in accordance with the third selected authority information.

Further, the data processing system according to the first preferred embodiment of the invention also includes an event recording module. The event recording module is resident in the system layer of the operating system, and is respectively coupled to the access control module and the message transmitting module. When the process managing module controls the application process to access the plurality of files in accordance with the first selected authority information, the event recording module records an event information relative to the access of the application process with the plurality of files and transmits the event information to the message transmitting module. The notification message transmitted by the message transmitting module includes the event information.

Further, the process managing module judges whether the process name of the application process is identical to one of the N predetermined process names of the N process authority status information stored in the process authority status recording module, and if yes, the process managing module controls the application process to access the plurality of files in accordance with the authority information of said one process authority status information whose predetermined process name is identical to the process name of the application process. The message transmitting module selectively transmits the notification message to the administrator system in accordance with the authority information of said one process authority status information.

In one embodiment, the first characteristic items can include a signature, a file name, a file date, a file size, a check sum, an issuer company, a product name, a path process, a version number, an execution parameter, or other characteristic items.

A data processing system according to a second preferred embodiment of the invention is capable of dynamically managing authorities of application processes. The data processing system according to the second preferred embodiment of the invention is capable of communicating with a process managing server. The process managing server is capable of communicating with an administrator system. The data processing system according to the second preferred embodiment of the invention includes a data storage device and at least one first processor. The data storage device therein stores a plurality of files. The at least one first processor is electrically connected to the data storage device, and functions in executing a first operating system. The first operating system has a system layer and an application layer. The first operating system includes a process authority status recording module, a first process managing module, a first message transmitting module, and an access control module. The process authority status recording module is resident in the application layer of the first operating system. The first process managing module is resident in the application layer of the first operating system, and is coupled to the process authority status recording module. The first message transmitting module is resident in the application layer of the first operating system, and is coupled to the first process managing module. The access control module is resident in the system layer of the first operating system, and is respectively coupled to the first process managing module and the data storage device. The process managing server includes at least one second processor. The at least one second processor functions in executing a second operating system. The second operating system includes an authority rule recording module, a process authority rule recording module, a second process managing module, and a second message transmitting module. The authority rule recording module therein stores a plurality of authority information. Each authority information includes a plurality of access action setting data. Each access action setting datum includes a respective authority setting datum and a respective notification setting datum. The process authority status recording module therein stores N process authority status information, where N is an integer equal to or larger than 0. Each process authority status information includes a predetermined process name, one of the plurality of authority information, and a respective first authority conversion rule datum. The process authority rule recording module therein stores a plurality of sequential process authority rule information. Each process authority rule information includes a respective first characteristic item, a respective first characteristic datum, one of the plurality of authority information, and a respective second authority conversion rule datum. The second process managing module is respectively coupled to the authority rule recording module and the process authority rule recording module. The second message transmitting module is coupled to the second process managing module. An application process is resident in the application layer of the first operating system, and is coupled to the first process managing module. The application process therein stores a plurality of second characteristic items and a plurality of second characteristic data. Each second characteristic item corresponds to one of the plurality of second characteristic data. When the application process is executed to access the plurality of files stored in the data storage device via the access control module, the first process managing module judges whether a process name of the application process is identical to one of the N predetermined process names of the N process authority status information stored in the process authority status recording module. And if no, the first message transmitting module transmits the second characteristic items and the second characteristic data of the application process to the process managing server. The second process managing module compares the second characteristic items and the second characteristic data of the application process in order with the first characteristic items and the first characteristic data of the plurality of sequential process authority rule information to determines a first selected authority information from the plurality of authority information of the plurality of sequential process authority rule information and a selected authority conversion rule datum from the plurality of first authority conversion rule data. The first process managing module controls the application process to access the plurality of files in accordance with the first selected authority information. The first process managing module records the process name, the first selected authority information, and the selected authority conversion rule datum in the process authority status recording module to form a new process authority status information that follows the N process authority status information. The second message transmitting module selectively transmits a notification message to the administrator system in accordance with the first selected authority information.

Further, if the second message transmitting module does not receive an instructional message sent by the administrator system in response to the notification message, the second process managing module changes the first selected authority information into a second selected authority information in accordance with the selected authority conversion rule datum. The second selected authority information is one of the plurality of authority information, and is not identical to the first selected authority information. The first process managing module controls the application process to access the plurality of files in accordance with the second selected authority information.

Further, if the second message transmitting module receives the instructional message sent by the administrator system in response to the notification message, the second process managing module changes the first selected authority information into a third selected authority information in accordance with the instructional message. The third selected authority information is one of the plurality of authority information, and is not identical to the first selected authority information. The first process managing module controls the application process to access the plurality of files in accordance with the third selected authority information.

Further, the first process managing module judges whether the process name of the application process is identical to one of the N predetermined process names of the N process authority status information stored in the process authority status recording module, and if yes, the first process managing module controls the application process to access the plurality of files in accordance with the authority information of said one process authority status information whose predetermined process name is identical to the process name of the application process. The second message transmitting module selectively transmits the notification message to the administrator system in accordance with the authority information of said one process authority status information.

Distinguishable from the prior art, the data processing system according to the invention can dynamically manage authorities of application processes. Thereby, the data processing system according to the invention can help the administrator to easily control the authorities of application processes whose process names have not yet been recorded in the process authority status information, so as not to allow the data processing system to operate abnormally or even to stop operating, or not to allow malicious processes to invade and then damage the data processing system.

The advantage and spirit of the invention may be understood by the following recitations together with the appended drawings.

### BRIEF DESCRIPTION OF THE APPENDED DRAWINGS

FIG. 1 is a schematic diagram of an architecture of a data processing system according to the first preferred embodiment of the invention.

FIG. 2 is a schematic diagram of an architecture of a modification of the data processing system according to the first preferred embodiment of the invention.

FIG. 3 is a schematic diagram of an example of a notification message transmitted by a message transmitting module of a data processing system according to the first preferred embodiment of the invention.

FIG. 4 is a schematic diagram of an architecture of a data processing system according to the second preferred embodiment of the invention.

### DETAILED DESCRIPTION OF THE INVENTION

Some preferred embodiments and practical applications of this present invention would be explained in the following paragraph, describing the characteristics, spirit, and advantages of the invention.

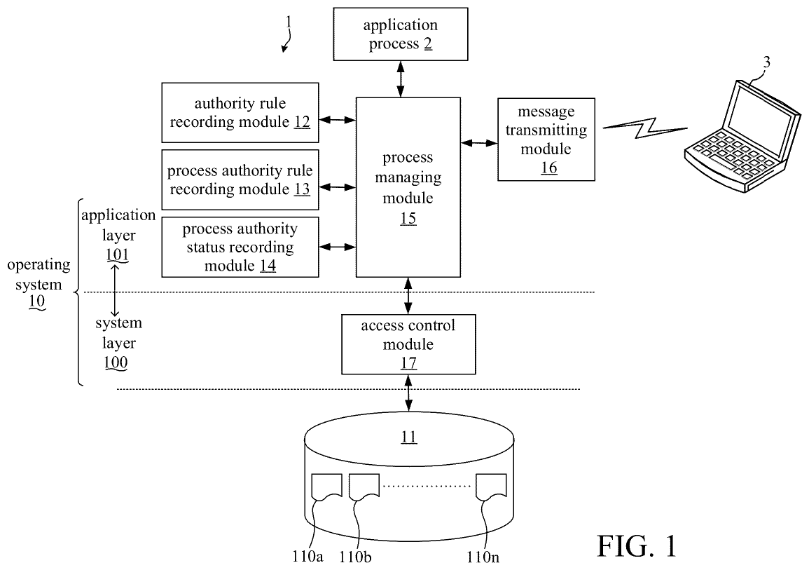

Referring to FIG. 1, the architecture of the data processing system 1 according to the first preferred embodiment of the invention is shown in FIG. 1. The data processing system 1 according to the first preferred embodiment of the invention is capable of dynamically managing authorities of an application process 2. The data processing system 1 according to the first preferred embodiment of the invention is capable of communicating with an administrator system 3.

In one embodiment, the data processing system 1 according to the first preferred embodiment of the invention can be one of various data processing systems such as a notebook computer, a desktop computer, a tablet computer, a smart phone, an industrial computer, a server, and the like.

As shown in FIG. 1, the data processing system 1 according to the first preferred embodiment of the invention includes a data storage device 11 and at least one processor (not shown in FIG. 1). The data storage device 11 therein stores a plurality of files (110a˜110n).

The at least one processor is electrically connected to the data storage device 11, and functions in executing an operating system 10. The operating system 10 has a system layer 100 and an application layer 101, and includes an authority rule recording module 12, a process authority rule recording module 13, a process authority status recording module 14, a process managing module 15, a message transmitting module 16, and an access control module 17.

The authority rule recording module 12 is resident in the application layer 101 of the operating system 10. The authority rule recording module 12 therein stores a plurality of authority information. Each authority information includes a plurality of access action setting data. Each access action setting datum includes a respective authority setting datum and a respective notification setting datum. In one embodiment,

The plurality of access action setting data include read, write, delete and so on. Referring to Table 1, the plurality of authority information of an example of the invention are listed in Table 1.

TABLE 1

authority information

| authority | access action | authority | notification |
|---|---|---|---|
| rule no. | setting | setting | setting |
| R1 | read | allow | notice |
| | write | allow | notice |
| | delete | allow | notice |
| R2 | read | allow | notice |
| | write | prohibit | notice |
| | delete | prohibit | notice |
| R3 | read | allow | without |
| | | | notice |
| | write | allow | without |
| | | | notice |
| | delete | allow | without |
| | | | notice |
| R4 | read | prohibit | notice |
| | write | prohibit | notice |
| | delete | prohibit | notice |

The process authority rule recording module 13 is resident in the application layer 101 of the operating system 10. The process authority rule recording module 13 therein stores a plurality of sequential process authority rule information. Each process authority rule information includes a respective first characteristic item, a respective first characteristic datum, one of the plurality of authority information, and a respective first authority conversion rule datum. In one embodiment, the plurality of first characteristic items can include a signature, a file name, a file date, a file size, a check sum, an issuer company, a product name, a path process, a version number, an execution parameter, or other characteristic items. Referring to Table 2, the plurality of sequential process authority rule information of an example of the invention are listed in Table 2. In Table 2, Feat1 and Feat2 are execution parameters.

TABLE 2

| | | | authority | |
|---|---|---|---|---|
| process | first | first | information | |
| authority | characteristic | characteristic | (authority | first authority |
| rule No. | item | datum | rule No.) | conversion rule |
| 1 | file name | Porg.exe | R1 | 3 hrs.→R1 |
| 2 | signature | Microsoft | R3 | N/A |
| 3 | Feat1 | Value1 | R# | T1 later→R# |
| | Feat2 | Value2 | R# | T2 later→R# |
| 4 | NA | NA | R1 | 3 hrs.→R2, |
| | | | | 3 hrs. again→R4 |

The process authority status recording module 14 is resident in the application layer 101 of the operating system 10. The process authority status recording module 14 therein stores N process authority status information, where N is an integer larger than or equal to 0. Each process authority status information includes a predetermined process name, one of the plurality of authority information, and a respective second authority conversion rule datum. Referring to Table 3, the N process authority status information of an example of the invention are listed in Table 3. In Table 3, the predetermined process name includes the path to the process.

TABLE 3

| | authority information | second authority |
|---|---|---|
| predetermined process name | (authority rule No.) | conversion rule |
| C:\Folder1\Porg1.exe | R1 | 3 hrs.→R3 |
| C:\Windows\notepad.exe | R3 | N/A |
| D:\virus1.exe | R2 | 3 hrs.→R4 |
| D:\Folder2\virus2.exe | R4 | N/A |

The process managing module 15 is resident in the application layer 101 of the operating system 10, and is respectively coupled to the authority rule recording module 12, the process authority rule recording module 13 and the process authority status recording module 14. The message transmitting module 16 is resident in the application layer 101 of the operating system 10, and is coupled to the process managing module 15. The access control module 17 is resident in the system layer 100 of the operating system 10, and is respectively coupled to the process managing module 15 and the data storage device 11.

The application process 2 is resident in the application layer 101 of the operating system 10, and is coupled to the process managing module 15. The application process 2 therein stores a plurality of second characteristic items and a plurality of second characteristic data. Each second characteristic item corresponds to one of the plurality of second characteristic data. When the application process 2 is executed to access the plurality of files (110a˜110n) stored in the data storage device 11 via the access control module 17, the process managing module 15 judges whether a process name of the application process 2 is identical to one of the N predetermined process names of the N process authority status information stored in the process authority status recording module 14. And if no, the process managing module 15 compares the second characteristic items and the second characteristic data of the application process 2 in order with the first characteristic items and the first characteristic data of the plurality of sequential process authority rule information to determines a first selected authority information from the plurality of authority information of the plurality of sequential process authority rule information and a selected authority conversion rule datum from the plurality of first authority conversion rule data. The process managing module 15 controls the application process 2 to access the plurality of files (110a˜110n) in accordance with the first selected authority information. The process managing module 15 records the process name, the first selected authority information, and the selected authority conversion rule datum in the process authority status recording module 14 to form a new process authority status information that follows the N process authority status information. The message transmitting module 16 selectively transmits a notification message to the administrator system 3 in accordance with the first selected authority information.

Further, if the message transmitting module 16 does not receive an instructional message sent by the administrator system 3 in response to the notification message, the process managing module 15 changes the first selected authority information into a second selected authority information in accordance with the selected authority conversion rule datum. The second selected authority information is one of the plurality of authority information, and is not identical to the first selected authority information. The process managing module 15 controls the application process 2 to access the plurality of files (110a˜110n) in accordance with the second selected authority information.

Further, if the message transmitting module 16 receives the instructional message sent by the administrator system 3 in response to the notification message, the process managing module 15 changes the first selected authority information into a third selected authority information in accordance with the instructional message. The third selected authority information is one of the plurality of authority information, and is not identical to the first selected authority information. The process managing module 15 controls the application process 2 to access the plurality of files (110a˜110n) in accordance with the third selected authority information.

Further, the process managing module 15 judges whether the process name of the application process 2 is identical to one of the N predetermined process names of the N process authority status information stored in the process authority status recording module 14, and if yes, the process managing module 15 controls the application process 2 to access the plurality of files (110a˜110n) in accordance with the authority information of said one process authority status information whose predetermined process name is identical to the process name of the application process 2. The message transmitting module 16 selectively transmits the notification message to the administrator system 3 in accordance with the authority information of said one process authority status information.

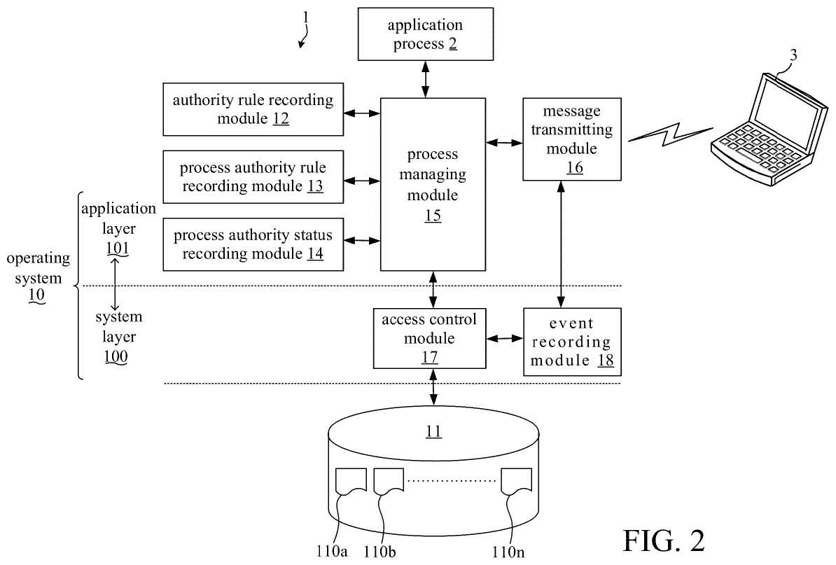

Referring to FIG. 2, the architecture of a modification of the data processing system 1 according to the first preferred embodiment of the invention is shown in FIG. 2. As shown in FIG. 2, further, the data processing system 1 according to the first preferred embodiment of the invention also includes an event recording module 18. The event recording module 18 is resident in the system layer 100 of the operating system 10, and is respectively coupled to the access control module 17 and the message transmitting module 16. When the process managing module 15 controls the application process 2 to access the plurality of files (110a˜110n) in accordance with the first selected authority information, the event recording module 18 records an event information relative to the access of the application process 2 with the plurality of files (110a˜110n) and transmits the event information to the message transmitting module 16. The notification message transmitted by the message transmitting module 16 includes the event information. The modules and devices in FIG. 2 that have the same numerical notations as those in FIG. 1 have the same or similar structures and functions, and will be not described in detail herein.

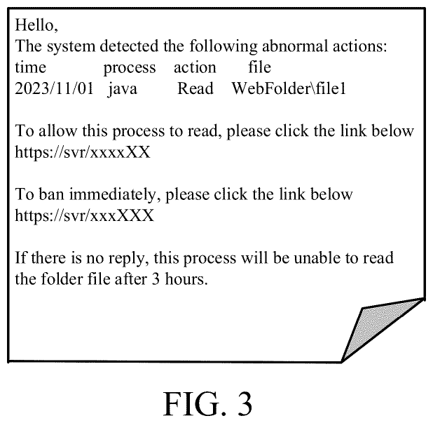

Referring to FIG. 3, FIG. 3 is a schematic diagram of an example of a notification message transmitted by the message transmitting module 16. The notification message shown in FIG. 3 includes the event information, and also includes a link that replies to allow the application process 2 to read and a link that replies to prohibit the application process 2 from accessing.

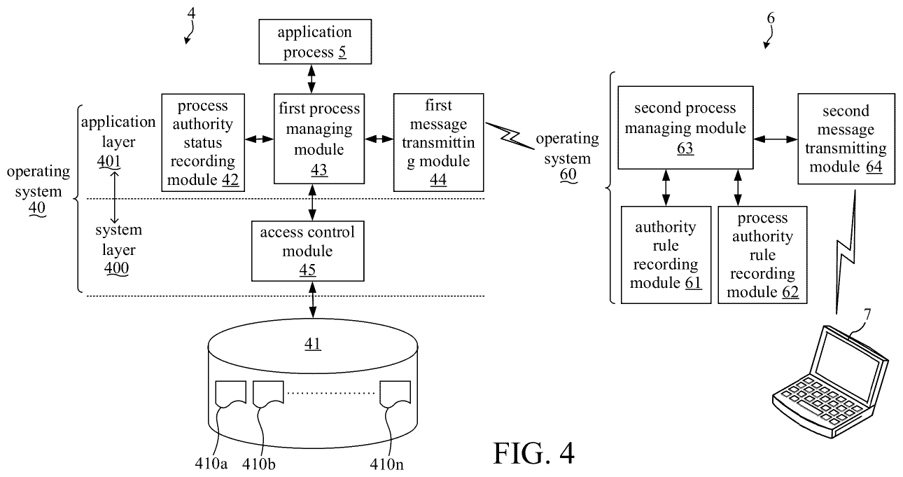

Referring to FIG. 4, the architecture of the data processing system 4 according to the second preferred embodiment of the invention is shown in FIG. 4. The data processing system 4 according to the second preferred embodiment of the invention is capable of dynamically managing authorities of an application process 5. The data processing system 4 according to the second preferred embodiment of the invention is capable of communicating with a process managing server 6. The process managing server 6 is capable of communicating with an administrator system 7.

In one embodiment, the data processing system 4 according to the second preferred embodiment of the invention can be one of various data processing systems such as a notebook computer, a desktop computer, a tablet computer, a smart phone, an industrial computer, a server, and the like.

As shown in FIG. 4, the data processing system 4 according to the second preferred embodiment of the invention includes a data storage device 41 and at least one first processor (not shown in FIG. 4). The data storage device 41 therein stores a plurality of files (410a˜410n).

The at least one first processor is electrically connected to the data storage device 41, and functions in executing a first operating system 40. The first operating system 40 has a system layer 400 and an application layer 401. The first operating system 40 includes a process authority status recording module 42, a first process managing module 43, a first message transmitting module 44, and an access control module 45.

The process authority status recording module 42 is resident in the application layer 401 of the first operating system 40. The first process managing module 43 is resident in the application layer 401 of the first operating system 40, and is coupled to the process authority status recording module 42. The first message transmitting module 44 is resident in the application layer 401 of the first operating system 40, and is coupled to the first process managing module 43. The access control module 45 is resident in the system layer 400 of the first operating system 40, and is respectively coupled to the first process managing module 43 and the data storage device 41.

The process managing server 6 includes at least one second processor (not shown in FIG. 4). The at least one second processor functions in executing a second operating system 60. The second operating system 60 includes an authority rule recording module 61, a process authority rule recording module 62, a second process managing module 63, and a second message transmitting module 64. The authority rule recording module 61 therein stores a plurality of authority information. Each authority information includes a plurality of access action setting data. Each access action setting datum includes a respective authority setting datum and a respective notification setting datum. The process authority status recording module 42 therein stores N process authority status information, where N is an integer equal to or larger than 0. Each process authority status information includes a predetermined process name, one of the plurality of authority information, and a respective first authority conversion rule datum.

The process authority rule recording module 62 therein stores a plurality of sequential process authority rule information. Each process authority rule information includes a respective first characteristic item, a respective first characteristic datum, one of the plurality of authority information, and a respective second authority conversion rule datum. In one embodiment, the plurality of first characteristic items can include a signature, a file name, a file date, a file size, a check sum, an issuer company, a product name, a path process, a version number, an execution parameter, or other characteristic items.

The second process managing module 63 is respectively coupled to the authority rule recording module 61 and the process authority rule recording module 62. The second message transmitting module 64 is coupled to the second process managing module 63.

The application process 5 is resident in the application layer 401 of the first operating system 40, and is coupled to the first process managing module 43. The application process 5 therein stores a plurality of second characteristic items and a plurality of second characteristic data. Each second characteristic item corresponds to one of the plurality of second characteristic data. When the application process 5 is executed to access the plurality of files (410a˜410n) stored in the data storage device 41 via the access control module 45, the first process managing module 43 judges whether a process name of the application process 5 is identical to one of the N predetermined process names of the N process authority status information stored in the process authority status recording module 42. And if no, the first message transmitting module 44 transmits the second characteristic items and the second characteristic data of the application process 5 to the process managing server 6. The second process managing module 63 compares the second characteristic items and the second characteristic data of the application process 5 in order with the first characteristic items and the first characteristic data of the plurality of sequential process authority rule information to determines a first selected authority information from the plurality of authority information of the plurality of sequential process authority rule information and a selected authority conversion rule datum from the plurality of first authority conversion rule data. The first process managing module 43 controls the application process 5 to access the plurality of files (410a˜410n) in accordance with the first selected authority information. The first process managing module 43 records the process name, the first selected authority information, and the selected authority conversion rule datum in the process authority status recording module 42 to form a new process authority status information that follows the N process authority status information. The second message transmitting module 64 selectively transmits a notification message to the administrator system 7 in accordance with the first selected authority information.

Further, if the second message transmitting module 64 does not receive an instructional message sent by the administrator system 7 in response to the notification message, the second process managing module 63 changes the first selected authority information into a second selected authority information in accordance with the selected authority conversion rule datum. The second selected authority information is one of the plurality of authority information, and is not identical to the first selected authority information. The first process managing module 43 controls the application process 5 to access the plurality of files (410a˜410n) in accordance with the second selected authority information.

Further, if the second message transmitting module 64 receives the instructional message sent by the administrator system 7 in response to the notification message, the second process managing module 63 changes the first selected authority information into a third selected authority information in accordance with the instructional message. The third selected authority information is one of the plurality of authority information, and is not identical to the first selected authority information. The first process managing module 43 controls the application process 5 to access the plurality of files (410a˜410n) in accordance with the third selected authority information.

Further, the first process managing module 43 judges whether the process name of the application process 5 is identical to one of the N predetermined process names of the N process authority status information stored in the process authority status recording module 42, and if yes, the first process managing module 43 controls the application process 5 to access the plurality of files (410a˜410n) in accordance with the authority information of said one process authority status information whose predetermined process name is identical to the process name of the application process 5. The second message transmitting module 64 selectively transmits the notification message to the administrator system 7 in accordance with the authority information of said one process authority status information.

In one example, the data processing system 1 according to the first preferred embodiment of the invention is set up as a web server, and the web application process is written in a java programming language. As with a typical web server, the data processing system 1 according to the first preferred embodiment of the invention first sets the WebFolder to protect the folder to be protected. At the start of the setting-up of the data processing system 1 according to the first preferred embodiment of the invention, there is no process authority status information in the “process authority status recording module 14”. Therefore, the process managing module 15 compares the plurality of second characteristic items and the plurality of second characteristic data of the java-based application process with the plurality of first characteristic items and the plurality of first characteristic data of the plurality of sequential process authority rule information in sequence, and naturally obtains the results of process authority rule number 4 as shown in Table 2. The information of process authority rule number 4 includes: first characteristic item: N/A; first characteristic datum: N/A; authority information (authority rule no.): R1; first authority conversion rule: 3 hrs.→R2, 3 hrs. again→R4. The process managing module 15 controls the java-based application process to access the files in the WebFolder in accordance with the authority information of authority rule no. R1, i.e., read, write and delete actions are allowed for the java-based application process, and a notification message must be transmitted to the administrator system 3 by the message transmitting module 16.

The notification message transmitted by the message transmitting module 16 is as shown in FIG. 3. The notification message includes an event information and also includes a link that replies to allow the java-based application process to read and a link that replies to prohibit the java-based application process from accessing. The process managing module 15 records the process name, the first selected authority information, and the selected authority conversion rule information of the java-based application process in the process authority status recording module 14 into a new process authority status information as shown in Table 4.

TABLE 4

| | authority information | second authority |
|---|---|---|
| predetermined process name | (authority rule No.) | conversion rule |
| C:\Folder1\java.exe | R1 | 3 hrs.→R2, |
| | | 3 hrs. again→R4 |

If the administrator is unable to determine whether the java-based application process should be a secure application process after receiving the notification message through the administrator system 3, the administrator has 3 hours to discuss with others or to gather information to confirm whether the java-based application process is a secure application process before responding to the notification message. If the administrator responds by granting the java-based application process the authority of all access actions, the process managing module 15 changes the information relative to the process authority status of the java-based application process, as shown in Table 5. After that, if any java-based application process accesses the files again, no abnormal event occurs.

TABLE 5

| | authority information | second authority |
|---|---|---|
| predetermined process name | (authority rule No.) | conversion rule |
| C:\Folder1\java.exe | R3 | N/A |

Obviously, the data processing system according to the invention is different from the data processing system of the prior art. If the data processing system of the prior art does not set the access authorities of the java-based application processes in advance, it would directly prohibit the java-based application processes, which would result in the non-execution of the web system without giving the administrators any time and space to discuss the query.

In the example, if the data processing system 1 according to the first preferred embodiment of the invention is compromised by a malicious process hacker that intends to access files, similarly, the process managing module 15 compares the plurality of second characteristic items and the plurality of second characteristic data of the hacker application process in sequence with the plurality of first characteristic items and the plurality of first characteristic data of the plurality of sequential process authority rule information in sequence, and naturally obtains the results of process authority rule number 4 as shown in Table 2. The information of process authority rule number 4 includes: first characteristic item: N/A; first characteristic datum: N/A; authority information (authority rule no.): R1; first authority conversion rule: 3 hrs.→R2, 3 hrs. again→R4. The process managing module 15 controls the hacker application process to access the files in the WebFolder in accordance with the authority information of authority rule no. R1, i.e., read, write, and delete actions are allowed for the hacker application process, and a notification message must be transmitted by the message transmitting module 16 to the administrator system 3. The process managing module 15 records the process name, the first selected authority information, and the selected authority conversion rule information of the hacker application process in the process authority status recording module 14 to form the new process authority status information as shown in Table 6.

TABLE 6

| | authority information | second authority |
|---|---|---|
| predetermined process name | (authority rule No.) | conversion rule |
| C:\Folder1\java.exe | R3 | N/A |
| C:\temp\hacker | R1 | 3 hrs.→R2, |
| | | 3 hrs. again→R3 |

If the administrator is unable to determine whether the hacker application process should be a secure application process after receiving the notification message through the administrator system 3, the administrator has 3 hours to discuss with others or to gather information to confirm whether the hacker application process is a secure application process before responding to the notification message. When the administrator responds by disabling the authority of all access actions to the hacker application process, the process managing module 15 will then change the process authority status information relative to the hacker application process, as shown in Table 7.

TABLE 7

| | authority information | second authority |
|---|---|---|
| predetermined process name | (authority rule No.) | conversion rule |
| C:\Folder1\java.exe | R3 | N/A |
| C:\temp\hacker | R4 | N/A |

If this web application process is also written in IIS programming language and w3wp.exe based on IIS programming language accesses the files in the data processing system 1 according to the first preferred embodiment of the invention, the process managing module 15 does not find “w3wp.exe” in the N process names of the N process authority status information in the process authority status recording module 14. Because the signature of w3wp.exe is “Microsoft”, the process managing module 15 compares the plurality of second characteristic items and the plurality of second characteristic data of w3wp.exe with the plurality of first characteristic items and the plurality of first characteristic data of the plurality of sequential process authority rule information in sequence, and naturally obtains the results of process authority rule number 2 as shown in Table 2. The information of process authority rule number 2 includes: first characteristic item: signature; first characteristic datum: Microsoft; authority information (authority rule no.): R3; first authority conversion rule: N/A. The process managing module 15 controls the access of w3wp.exe to the files in the WebFolder in accordance with the authority information of authority rule no. R3, i.e., read, write, and delete actions are allowed for w3wp.exe and without transmitting a notification message to the administrator system 3. The process managing module 15 records the process name, the first selected authority information, and the selected authority conversion rule information of w3wp.exe in the process authority status recording module 14 into a new process authority status information as shown in Table 8.

TABLE 8

| | authority | second |
|---|---|---|
| | information | authority |
| | (authority | conversion |
| predetermined process name | rule No.) | rule |
| C:\Folder1\java.exe | R3 | N/A |
| C:\temp\hacker | R4 | N/A |
| C:\Windows\System32\inetsrv\w3wp.exe | R3 | N/A |

If php.exe, a commonly used program on the web page, also accesses the files in the data processing system 1 according to the first preferred embodiment of the invention, the process managing module 15 does not find “php.exe” in the N process names of the N process authority status information in the process authority status recording module 14. Therefore, the process managing module 15 compares the plurality of second characteristic items and the plurality of second characteristic data of php.exe with the plurality of first characteristic items and the plurality of first characteristic data of the plurality of sequential process authority rule information, and naturally obtains the results of process authority rule number 4 as shown in Table 2. The information of process authority rule number 4 includes: first characteristic item: N/A; first characteristic datum: N/A; authority information (authority rule no.): R1; first authority conversion rule: 3 hrs.→R2, 3 hrs. again→R4. The process managing module 15 controls the access of php.exe to the files in the WebFolder in accordance with the authority information of authority rule no. R1, i.e., read, write, and delete actions are allowed for php.exe, and a notification message must be transmitted by the message transmitting module 16 to the administrator system 3. The process managing module 15 records the process name, the first selected authority information, and the selected authority conversion rule information of php.exe in the process authority status recording module 14 to form the new process authority status information as shown in Table 9

TABLE 9

| | authority | second |
|---|---|---|
| | information | authority |
| | (authority | conversion |
| predetermined process name | rule No.) | rule |
| C:\Folder1\java.exe | R3 | N/A |
| C:\temp\hacker | R4 | N/A |
| C:\Windows\System32\inetsrv\w3wp.exe | R3 | N/A |
| C:\php\php.exe | R1 | 3 hrs.→R2, |
| | | 3 hrs. |
| | | again→R4 |

If the administrator forgets to handle the notification message after receiving the notification message through the administrator system 3, after 3 hours, the process managing module 15 will change the authority information (authority rule number) of php.exe into R2, which will only allow php.exe to read and will not prevent the web system from functioning, but will prohibit php.exe from writing. The process managing module 15 changes the process authority status information relative to php.exe as shown in Table 10.

TABLE 10

| | authority | second |
|---|---|---|
| | information | authority |
| | (authority | conversion |
| predetermined process name | rule No.) | rule |
| C:\Folder1\java.exe | R3 | N/A |
| C:\temp\hacker | R4 | N/A |
| C:\Windows\System32\inetsrv\w3wp.exe | R3 | N/A |
| C:\php\php.exe | R1 | 3 hrs.→R4 |

At this point, if php.exe has to execute the write action again, the message transmitting module 16 transmits a notification message including the event information to the administrator system 3 again to notify the administrator. After the administrator receives the notification message, if the administrator remembers to handle it this time, php.exe is added to the secure process, and the subsequent actions are the same as those described above, and php.exe becomes a secure process, and there are no more abnormal events.

With the detailed description of the above preferred embodiments of the invention, it is clear to understand that the data processing system according to the invention can dynamically manage authorities of application processes. Thereby, the data processing system according to the invention can help the administrator to easily control the authorities of application processes whose process names have not yet been recorded in the process authority status information, so as not to allow the data processing system to operate abnormally or even to stop operating, or not to allow malicious processes to invade and then damage the data processing system.

With the example and explanations above, the characteristics and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing system, capable of communicating with an administrator system, comprising:
a data storage device, therein storing a plurality of files;
at least one processor, being electrically connected to the data storage device and functioning in executing an operating system, the operating system having a system layer and an application layer, the operating system comprising:
an authority rule recording module, being resident in the application layer and therein storing a plurality of authority information, each authority information comprising a plurality of access action setting data, each access action setting datum comprising a respective authority setting datum and a respective notification setting datum;
a process authority rule recording module, being resident in the application layer and therein storing a plurality of sequential process authority rule information, each process authority rule information comprising a respective first characteristic item, a respective first characteristic datum, one of the plurality of authority information, and a respective first authority conversion rule datum;
a process authority status recording module, being resident in the application layer and therein storing N process authority status information, each process authority status information comprising a predetermined process name, one of the plurality of authority information, and a respective second authority conversion rule datum, wherein N is an integer larger than or equal to 0;
a process managing module, resident in the application layer and respectively coupled to the authority rule recording module, the process authority rule recording module and the process authority status recording module;
a message transmitting module, resident in the application layer and coupled to the process managing module; and
an access control module, resident in the system layer and respectively coupled to the process managing module and the data storage device,
wherein an application process is resident in the application layer and coupled to the process managing module, the application process therein stores a plurality of second characteristic items and a plurality of second characteristic data, each second characteristic item corresponds to one of the plurality of second characteristic data, when the application process is executed to access the plurality of files stored in the data storage device via the access control module, the process managing module judges whether a process name of the application process is identical to one of the N predetermined process names of the N process authority status information stored in the process authority status recording module, and if no, the process managing module compares the second characteristic items and the second characteristic data of the application process in order with the first characteristic items and the first characteristic data of the plurality of sequential process authority rule information to determines a first selected authority information from the plurality of authority information of the plurality of sequential process authority rule information and a selected authority conversion rule datum from the plurality of first authority conversion rule data, the process managing module controls the application process to access the plurality of files in accordance with the first selected authority information, the process managing module records the process name, the first selected authority information, and the selected authority conversion rule datum in the process authority status recording module to form a new process authority status information that follows the N process authority status information, the message transmitting module selectively transmits a notification message to the administrator system in accordance with the first selected authority information.

2. The data processing system of claim 1, wherein if the message transmitting module does not receive an instructional message sent by the administrator system in response to the notification message, the process managing module changes the first selected authority information into a second selected authority information in accordance with the selected authority conversion rule datum, the second selected authority information is one of the plurality of authority information and is not identical to the first selected authority information, and the process managing module controls the application process to access the plurality of files in accordance with the second selected authority information.

3. The data processing system of claim 2, wherein if the message transmitting module receives the instructional message sent by the administrator system in response to the notification message, the process managing module changes the first selected authority information into a third selected authority information in accordance with the instructional message, the third selected authority information is one of the plurality of authority information and is not identical to the first selected authority information, and the process managing module controls the application process to access the plurality of files in accordance with the third selected authority information.

4. The data processing system of claim 2, wherein the operating system further comprises:
an event recording module, resident in the system layer and respectively coupled to the access control module and the message transmitting module, wherein when the process managing module controls the application process to access the plurality of files in accordance with the first selected authority information, the event recording module records an event information relative to the access of the application process with the plurality of files and transmits the event information to the message transmitting module, and the notification message transmitted by the message transmitting module comprises the event information.

5. The data processing system of claim 1, wherein the process managing module judges whether the process name of the application process is identical to one of the N predetermined process names of the N process authority status information stored in the process authority status recording module, and if yes, the process managing module controls the application process to access the plurality of files in accordance with the authority information of said one process authority status information whose predetermined process name is identical to the process name of the application process, the message transmitting module selectively transmits the notification message to the administrator system in accordance with the authority information of said one process authority status information.

6. The data processing system of claim 1, wherein the first characteristic items comprises one selected from the group consisting of a signature, a file name, a file date, a file size, a check sum, an issuer company, a product name, a path process, a version number, and an execution parameter.

7. A data processing system, capable of communicating with a process managing server, the process managing server being capable of communicating with an administrator system, said data processing system comprising:
a data storage device, therein storing a plurality of files; and
at least one first processor, being electrically connected to the data storage device and functioning in executing a first operating system, the first operating system having a system layer and an application layer, the first operating system comprising:
a process authority status recording module, being resident in the application layer;
a first process managing module, resident in the application layer and coupled to the process authority status recording module;
a first message transmitting module, resident in the application layer and coupled to the first process managing module; and
an access control module, resident in the system layer and respectively coupled to the first process managing module and the data storage device;
wherein the process managing server comprises;
at least one second processor, functioning in executing a second operating system, the second operating system comprising:
an authority rule recording module, therein storing a plurality of authority information, each authority information comprising a plurality of access action setting data, each access action setting datum comprising a respective authority setting datum and a respective notification setting datum, wherein the process authority status recording module therein stores N process authority status information, N is an integer equal to or larger than 0, each process authority status information comprises a predetermined process name, one of the plurality of authority information, and a respective first authority conversion rule datum;
a process authority rule recording module, therein storing a plurality of sequential process authority rule information, each process authority rule information comprising a respective first characteristic item, a respective first characteristic datum, one of the plurality of authority information, and a respective second authority conversion rule datum;
a second process managing module, respectively coupled to the authority rule recording module and the process authority rule recording module; and
a second message transmitting module, coupled to the second process managing module;
wherein an application process is resident in the application layer and coupled to the first process managing module, the application process therein stores a plurality of second characteristic items and a plurality of second characteristic data, each second characteristic item corresponds to one of the plurality of second characteristic data, when the application process is executed to access the plurality of files stored in the data storage device via the access control module, the first process managing module judges whether a process name of the application process is identical to one of the N predetermined process names of the N process authority status information stored in the process authority status recording module, and if no, the first message transmitting module transmits the second characteristic items and the second characteristic data of the application process to the process managing server, the second process managing module compares the second characteristic items and the second characteristic data of the application process in order with the first characteristic items and the first characteristic data of the plurality of sequential process authority rule information to determines a first selected authority information from the plurality of authority information of the plurality of sequential process authority rule information and a selected authority conversion rule datum from the plurality of first authority conversion rule data, the first process managing module controls the application process to access the plurality of files in accordance with the first selected authority information, the first process managing module records the process name, the first selected authority information, and the selected authority conversion rule datum in the process authority status recording module to form a new process authority status information that follows the N process authority status information, the second message transmitting module selectively transmits a notification message to the administrator system in accordance with the first selected authority information.

8. The data processing system of claim 7, wherein if the second message transmitting module does not receive an instructional message sent by the administrator system in response to the notification message, the second process managing module changes the first selected authority information into a second selected authority information in accordance with the selected authority conversion rule datum, the second selected authority information is one of the plurality of authority information and is not identical to the first selected authority information, and the first process managing module controls the application process to access the plurality of files in accordance with the second selected authority information.

9. The data processing system of claim 8, wherein if the second message transmitting module receives the instructional message sent by the administrator system in response to the notification message, the second process managing module changes the first selected authority information into a third selected authority information in accordance with the instructional message, the third selected authority information is one of the plurality of authority information and is not identical to the first selected authority information, and the first process managing module controls the application process to access the plurality of files in accordance with the third selected authority information.

10. The data processing system of claim 7, wherein the first process managing module judges whether the process name of the application process is identical to one of the N predetermined process names of the N process authority status information stored in the process authority status recording module, and if yes, the first process managing module controls the application process to access the plurality of files in accordance with the authority information of said one process authority status information whose predetermined process name is identical to the process name of the application process, the second message transmitting module selectively transmits the notification message to the administrator system in accordance with the authority information of said one process authority status information.
